(19) United States
(12) Patent Application Publication
(10) Pub. No.: US 2003/0187813 A1
(43) Pub. Date: Oct. 2, 2003

(54) System and method for identifying relationship paths to a target entity

(76) Inventors: Neal D. Goldman, New York, NY (US); William Murphy, New York, NY (US)

Correspondence Address: Philip H. Gottfried, Amster, Rothstein & Ebenstein, 90 Park Avenue, New York, NY, 10016, US

(21) Appl. No.: 10/107,891

(22) Filed: Mar. 26, 2002

(51) Int. Cl. G06F 7/00

(52) U.S. Cl. 707/1

(57) ABSTRACT

A method of identifying a relationship path from a user or from a start entity to a target entity by establishing a computer platform including an algorithm for determining the shortest path; establishing a central database of combined public and private information comprising a plurality of items of contact information; assigning a unique, relational identifier to each item of contact information in said central database; obtaining at least one client database of contact information comprising a plurality of items of contact information; assigning a unique, relational identifier to each item of contact information in said client database; loading said client database into said central database; integrating said central database with said client database; providing a user interface to said platform for a user to enter start or user entities and a target entity; determining whether relationship paths exist to said target entity; and identifying said relationship paths.

### FIELD OF INVENTION

This invention is in the field of business networking, and more particularly, in the field of identifying a target person whom a user wishes to contact but does not personally know, and determining an efficient method by which such personal contact may be achieved.

### BACKGROUND OF THE INVENTION

The contacts that a business person possesses are very important in the maintenance and promotion of that person's business. The well-known adage “it's not what you know, but who you know” has a great amount of truth to it. The ROLODEX desk-top revolving rotary file, a manually maintained set of contacts on individual cards, was an early and eventually universally recognized contact database. While the ROLODEX desk-top file served its purpose of organizing and maintaining a collection of business and personal contacts, it did not serve the purpose of pointing out to its owner which contact would be the best one for achieving the goal of establishing a relationship to a particular target entity. If the owner's collection of contacts was very limited, or if his or her memory failed to establish a relationship to the target entity, the owner could not glean from his or her contacts that they know someone at the target entity, or that one of their contacts knows someone at the target entity. In that event, the owner would have to rely on asking others if they had any contacts with the particular target entity. Those other individuals would still have to rely on their ROLODEX desk-top files and they would encounter the same problems.

In addition to being unreliable, inaccurate and incomplete, the process of establishing contacts through the use of a ROLODEX desk-top file was also inefficient and time consuming. The innovation of the computerized desk-top file sped up the process of searching for contacts maintained in a database. It allowed an individual to store his or her contact information in a database and conduct a search in that database relatively quickly. This individual's database could then be combined with the contact information of his or her colleagues or co-workers, and a search for a contact could be conducted in this enlarged database of contacts. Such a relationship management tool may be exemplified by the Client Relation Management system of Microsoft Outlook®.

However, Microsoft Outlook® and other systems that were the state of the art prior to the present invention provided aggregate contact information of all of the individuals within that individual's organization. Although these systems could be used to adequately, though in a cumbersome and inefficient manner, indicate which person within the individual's organization had a relationship with the target entity, they did not adequately identify relationships between persons within the individual's organization and other outside individuals who had a relationship with the target entity. For example, while prior systems could identify that Bob has had a meeting with Jim Smith, and therefore Bob could be called to get to Jim, they are limited to identifying only Bob who was within their organization, as opposed to identifying other individuals outside their office who have contacts with Jim.

Other methods of establishing a relationship to a target entity include manual searching through hard copy directories or web sites to find an individual to whom a “cold call” could be placed. In addition to being tedious and time consuming, such methods are impersonal, and often unsuccessful. The present invention, in addition to providing a quick and efficient method of establishing relationship paths, provides a reliable method of obtaining trusted referrals and introductions, resulting in greater success in contacting the target entity.

The present invention utilizes a reliable central database of information and contacts on a great many public and private business institutions, bot U.S. and foreign. Thus, there is no need for the individual attempting to locate the target entity to manually search all available sources of information, since the present invention provides a large and robust database which may be integrated with an individual's contact information database. In addition to quickly and thoroughly locating contacts which may establish a relationship with the target entity, the present invention utilizes state of the art algorithms to analyze the “best” relationship paths to a given target. Thus, the adage aforementioned becomes: “It's not what you know, but who you know and who they know—and knowing how to contact the people they know.”

### SUMMARY OF THE INVENTION

It is a goal of the present invention to provide an efficient and reliable system and method for clients to establish contacts. The invention accomplishes this by identifying all interconnecting relationship paths between the client, or user of the invention and the target entity that the client desires to contact. The relationship paths may be direct, in which case they are from the user directly to the target entity, or they may be indirect, involving one or more intermediaries between the user and the target entity. The user plus the number of intermediaries determines the degree of separation of the relationship path. Therefore, a relationship path with one degree of separation involves the user and zero intermediaries, and a path with two degrees of separation involves the user and one intermediary.

For this invention to be effective, there must be a central database of public and private contact information with which client contact information is integrated. It is important that this system be continually updated as contact information is constantly changing. There may be multiple client databases that are integrated with one central database. Once a target entity is entered by the user of the invention, the method searches through the combined database identifying all channels of communication, or relationship paths between the user and the target entity. The method includes a scoring system which rates the quality of the relationship. This scoring system is combined with a “shortest path algorithm” to determine the best path from the starting point, which is a given entity, usually the user of the invention, to the finishing point, which is the target entity. All of the identified paths are finally identified to the user in ranked order.

### BRIEF DESCRIPTION OF THE DRAWINGS

In the drawings:

FIG. 1 shows a flow chart illustrating one embodiment of the invention.

FIG. 2 shows a flow chart illustrating a second embodiment of the invention.

FIG. 3 shows a flow chart illustrating a third embodiment of the invention.

FIG. 4 shows a flow chart illustrating a fourth embodiment of the invention.

FIG. 5 shows a flow chart illustrating a fifth embodiment of the invention.

FIG. 6 shows an exemplary screen of the website used to enter a target entity by a user.

FIG. 7 shows an exemplary screen of the relationship paths identified by the present invention.

FIG. 8 shows an exemplary screen of the website used to enter a target entity by a user.

### DESCRIPTION OF THE PREFERRED EMBODIMENTS

According to one preferred embodiment of the present invention, there is provided a method of identifying a relationship path to a target entity. The present invention integrates a client's contact information database (client database) with the public and private databases of individuals and entities (central database) to identify and display the relationships of the user of the invention with other individuals or entities in the public and private sector.

A central database of a combined plurality of items of publicly available information, information from third parties and proprietary and nonproprietary information is initially established. Such information may include, without limitation, the names of individuals, such as family members, friends, acquaintances, alumni, and prior or present colleagues and co-workers. Such information may also include companies, firms, universities, common board memberships, deals worked on together and common membership with certain organizations, such as trade associations, professional associations, fraternities, charitable organizations, golf clubs, free masons or political parties. Theoretically, any information that could establish any commonality of interest could be identified.

This central database is constantly maintained by a host entity, such as Capital IQ. This involves maintaining the central database on computer servers at a secure hosting facility, such as Qwest or Globix. The central database is created by aggregating multiple third party data sources which cover many or all of the publicly traded companies in the United States, EU company data for publicly traded companies, and by the manual inputting of data on private entities. Technologists maintain the security and efficiency of the database. All of the items of information in the central database are assigned a unique, relational identifier for every entity, individual and relationship within the central database. These unique identifiers serve to relate certain pieces of data to other unique pieces of data.

At least one client database of a plurality of items of public and private information is obtained, and each item of this proprietary and nonproprietary information is also assigned a unique, relational identifier. A client's database is its internal Client Relation System, such as Microsoft Outlook®. A client is capable of integrating its contact database into the central database. The client has the option of maintaining its own Client Relation Management system and integrating it with the central database, such as the Capital IQ database, or it can load all of its proprietary and non-proprietary contact information into the central database through a template and use that system as its Client Relation Management system. Regardless of the method chosen, the particular client's information remains confidential and is not shared with anyone, unless a particular client decides to do so.

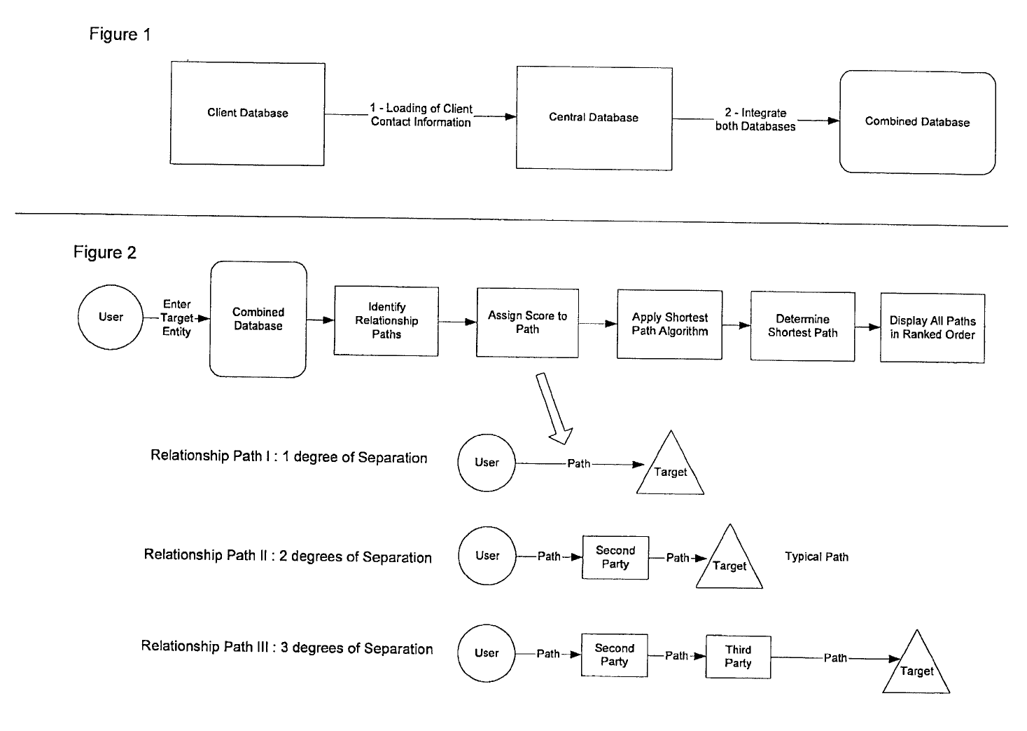

Referring to FIG. 1, the contact information in the client database is loaded into the central database (1). Once this is accomplished, the present invention integrates the client database with the central database to yield a combined database (2). Integrating may also include mapping of unique identifiers in the client database to unique identifiers in the central database. Once this occurs, the client may then use the present invention to identify how to “get to” a particular individual both within its organization and outside its organization. The client always has the opportunity of updating its client database by adding additional information. The client also has the opportunity of updating the central database by adding additional information, which information can be maintained as proprietary to the particular user.

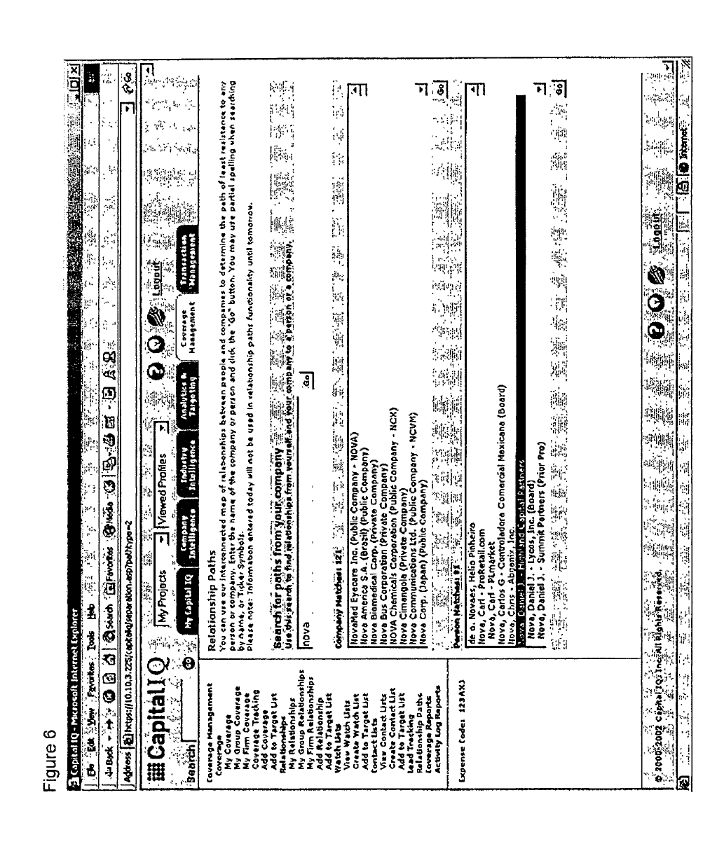

As shown in FIG. 6, the client or the user of the present invention, through the Capital IQ website, enters the target entity to which he or she wishes to establish a relationship path. The target entity is either a target person or a target company. If the targeted contact is a target company, the target entity will be an individual with a relationship to the company, since it is not likely to have a relationship with a company that does not involve an individual. Even when an individual covers a company, in order to ultimately contact that company, an individual at that company would need to be contacted. The present invention then determines whether a plurality of relationship paths exist from the user to the target entity, identifies the relationship paths, and ranks them based on the “shortest path” to the target entity.

Alternatively, instead of achieving a user to target entity relationship path, the user may decide to establish a “starting entity” to target entity relationship path as opposed to a user to target entity path. In this case, the present invention identifies a particular starting entity that has a relationship with the target entity. This starting entity may or may not have a relationship with the user. Additionally, the starting entity may exist in either the client database, or only in the central database. When the starting entity is located solely in the central database, the client database may not be employed at all. In fact, it may not be necessary to obtain and integrate a client database at all. This alternative means of using the method is particularly useful to service providers who can inform their clients that the client herself actually has a relationship with another third party that she is trying to do business with.

Various relationship paths may be identified, with different degrees of separation. When a user or starting entity enters a target entity, the invention uses a “shortest path algorithm” and a scoring system to analyze all of the relationship paths identified.

A shortest path algorithm is a method for determining the shortest distance from a source node to a single target node in a network. As seen in the Appendix attached hereto, there are examples of shortest path algorithms and methods of using the same which may be readily applied by any person skilled in the art. As shown in FIG. 5, there are various paths between the user and the target entity, and each path is assigned a score from 1 to 10. A relationship path from user to A, A to B, B to target entity has a total score of 1+2+3=6. A relationship path from user to C, C to B, B to target entity has a total score of 8+6+3=17. Since the former path has a lower score, it is the best and shortest path.

When the relationship path has a first degree of separation, there is a direct relationship between the user or starting entity and the target entity. With respect to this first degree of separation, there are two paths to the target entity. In the first path, there is a personal relationship. In this instance, the user or starting entity has a direct relationship with the target entity. In the second path, the user or starting entity “covers” the course of business of the target entity where covers or coverage of a target requires the user or starting entity to get as close as possible to the target entity.

Coverage of a target entity requires that the user or any party get as close as possible to the target entity. Inmanytypes of companies that sell products or services, there often exists a relationship coordinator, and sometimes a relationship coordination team. For example, IBM sells hardware and services to Ernst and Young. While there are many people who handle various aspects of Ernst and Young's business (programming, installing, etc.), there exists a person or team of people who cover Ernst and Young by specifically focusing on achieving increased sales, and customer satisfaction with prior sales.

In the banking industry, for example, there exist a group of people at Merrill Lynch that cover General Electric. This group is constantly communicating with all the various departments of General Electric in an attempt to solicit additional business. Bankers cover a company by monitoring the activities of that company, tracking relationships, and attaining interaction with the company and its professionals.

Investment bankers have a variety of services that they can sell to both private equity funds and corporations and it is important that they stay on top of all the activities which occur at these entities so that opportunities which could potentially generate fee income could be identified. The types of activities investment bankers would monitor include debt and equity financing, mergers and acquisitions, public offerings, trading information, financials, market data, industry information, filings, laws and regulation that might impact the business, etc. The person covering a company monitors all relevant information with respect to such company to enhance his ability to predict how the company will perform in the future. Thus, covering a company involves interaction with a broad range of people, thereby increasing the likelihood that almost any person in the organization may be contacted.

When the relationship path has a second degree of separation, there is a relationship between the user or starting entity, an intermediary, or second party, and the target entity. With respect to this second degree of separation, there are two paths from the second party to the target entity. In the first path, there is a personal relationship. In this instance, the second party has a direct relationship with the target entity. In the second path, the second party “covers” the entire course of business of the target entity.

After the relationship paths are identified, the present invention assigns a score to each of the relationship paths it has identified. The best path is given the lowest score. Any type of scoring system may be employed. The preferred scoring system is alphabetical, with the lowest score indicated by the letter “A.”

When a relationship path with a first degree of separation is identified, the invention may assign an “A” when the user or starting entity has a direct relationship with the target entity, and a “B” when the user or starting entity “covers” the target entity. When a relationship path with a second degree of separation is identified, the invention may assign a “C” when a second party has a direct relationship with the target entity and a “D” when the second party covers the target entity.

If the target entity is not related to the user or starting entity through a first or second degree of separation, the invention simultaneously identifies that fact and subsequently searches for other relationship paths. A path with a third degree of separation establishes a user or starting entity to a second party, a second party to a third party, and a third party to a target entity relationship. A path with a fourth degree of separation establishes a user or starting entity to a second party, a second party to a third party, a third party to a fourth party, and a fourth party to a target entity relationship. A path with a fifth degree of separation establishes a user or starting entity to a second party, a second party to a third party, a third party to a fourth party, a fourth party to a fifth party, and a fifth party to a target entity relationship. A path with a sixth degree of separation establishes a user or starting entity to a second party, a second party to a third party, a third party to a fourth party, a fourth party to a fifth party, a fifth party to a sixth party, and a sixth party to a target entity relationship. Additional relationship paths with infinite degrees of separation may be identified.

When relationship paths with three degrees of separation are identified, a different scoring method is employed. A separate score is obtained for each relationship path. A first score is assigned to the relationship path from the user or starting entity to the third party, and a second score is assigned to the relationship path from the third party to the target entity.

A first score is obtained in the manner described above for one and two degrees of separation, for each such relationship path from the user or starting entity to the third party (instead of the target entity). Thus, the invention may assign an “A” when the user or starting entity has a direct relationship with the third party, a “B” when the user or starting entity “covers” the third party, a “C” when a second party has a direct relationship with the third party and a “D” when the second party covers the third party.

A second score is obtained by assigning an “A” when the third party is a board member with the target entity, a “B” when the third party works with the target entity, a “C” when the third party covers the target entity, a “D” when the third party works at the company where the target entity is a board member, and an “E” when the third party is a board member at the company where the target entity is employed. Additional scores may be assigned to additional types of paths, such as those described above in the “Background of the Invention.” The first score and the second score are combined for each relationship path. The lowest combined score is then determined using the assigned scores and a shortest path algorithm, and the shortest path is identified.

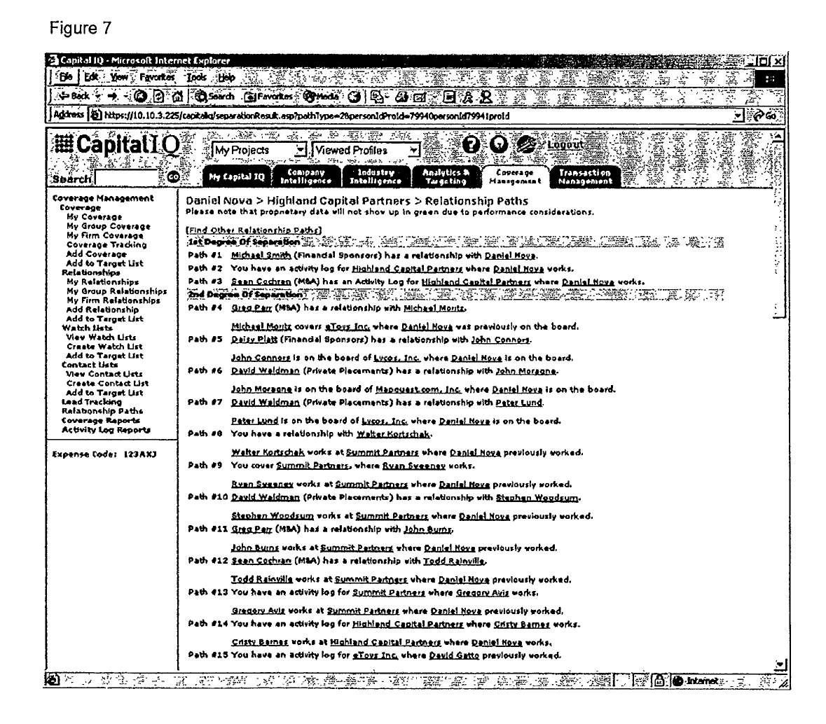

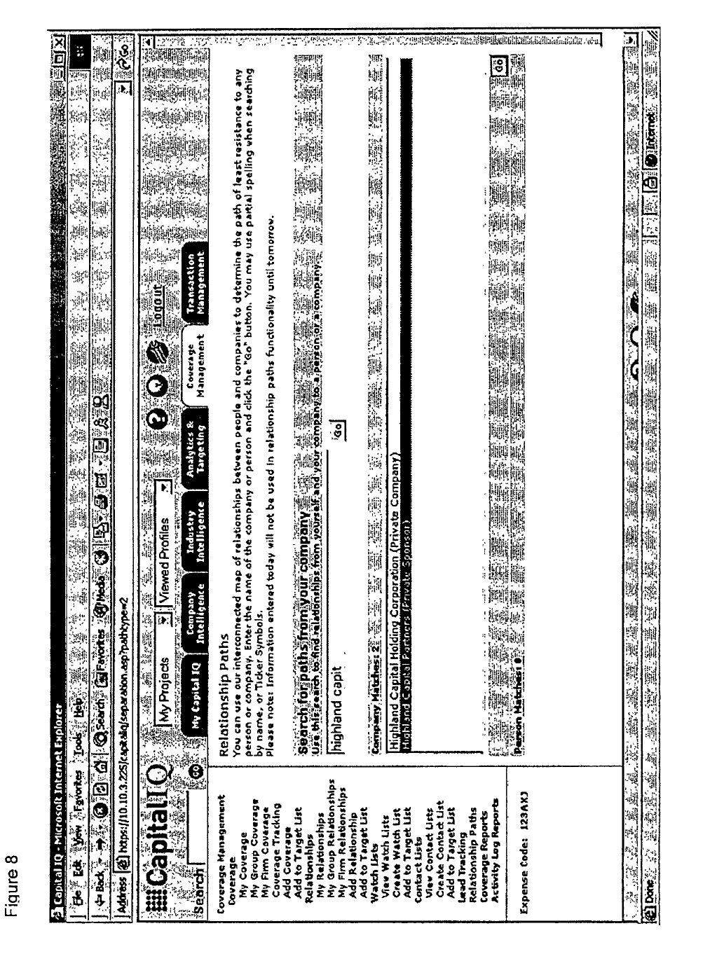

As shown in FIG. 7, once the shortest relationship path is determined using calculated scores and the shortest path algorithm, the results are displayed to the user. The results include all the relationship paths that the invention has identified, and they are listed in ranked order. For example, the relationship path with the lowest, or best score is first in the list of results, and the relationship path with the highest, or worst score is listed last. As shown in FIG. 6, the target entity entered by the user is Daniel Nova. This is the person the user would like to contact. FIG. 7 lists all the relationship paths identified by the invention. The best relationship path identified is Path #1, from Michael Smith to Daniel Nova. The worst relationship path is Path #2, from Todd Erikson to Keith Benjamin, who works at Highland Capital Partners with Daniel Nova. As shown in FIG. 8, the target entity entered by the user is Highland Capital Partners. Since the target entity entered is a company, the method identifies an individual at the company whom the user may contact. Since all the relationship paths are displayed, this gives the user the option of choosing which relationship path it would like to employ.

FIG. 2 represents a preferred embodiment of the invention. The method begins with the user entering the target entity (1). The combined database then identifies all the relationship paths from the user to the target entity. Relationship paths with one, two and three degrees of separation are identified. The invention then assigns a score to each path, applies the shortest path algorithm, and determines the shortest relationship path of the three identified. All three paths are then displayed to the user in ranked order.

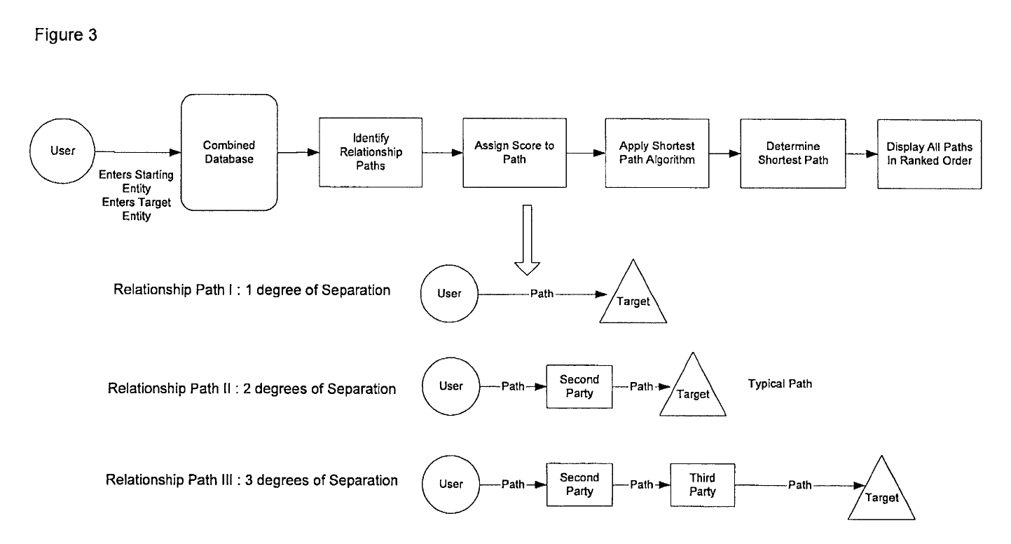

The method referred to in FIG. 3 begins with the user entering the starting entity (1) and the target entity (2). The combined database then identifies all the relationship paths from the starting entity to the target entity. Relationship paths with one, two and three degrees of separation are identified. The invention then assigns a score to each path, applies the shortest path algorithm, and determines the shortest relationship path of the three identified. All three paths are then displayed to the user in ranked order.

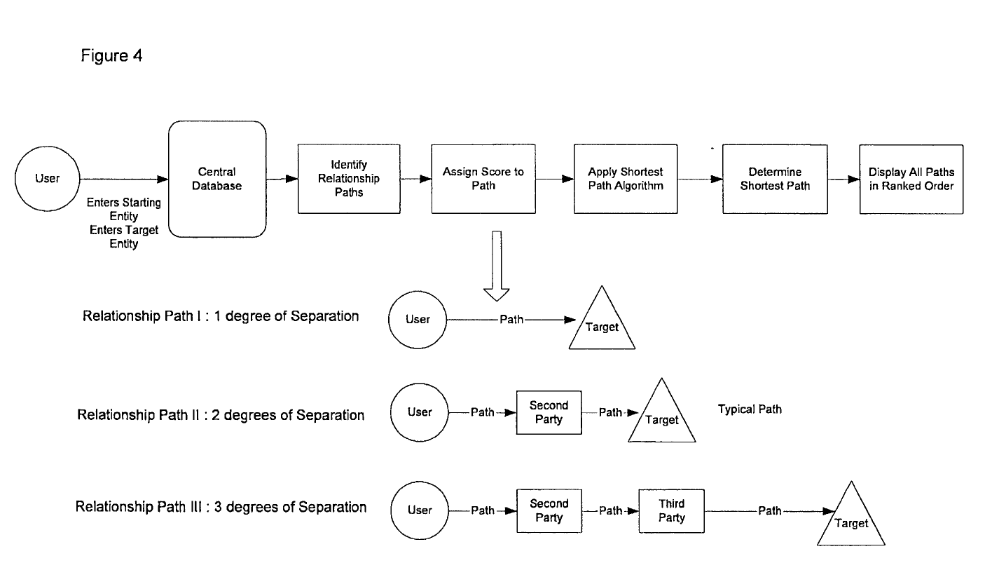

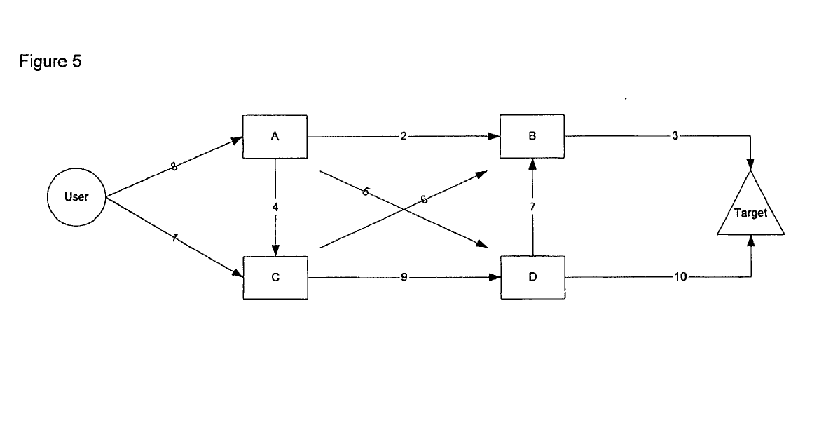

FIG. 4 represents a method which also begins with the user entering the starting entity (1) and the target entity (2), but only the central database identifies all the relationship paths from the starting entity to the target entity. There is no combined database and the client database is not employed at all.

We claim:

1. A method of identifying a relationship path to a target entity comprising the steps of:
(a) establishing a central database of combined public and private information comprising a plurality of items of contact information;
(b) assigning a unique, relational identifier to each item of contact information in said central database;
(c) obtaining at least one client database of contact information comprising a plurality of items of contact information;
(d) assigning a unique, relational identifier to each item of contact information in said client database;
(e) loading said client database into said central database;
(f) integrating said central database with said client database;
(g) entering a target entity by a user;
(h) determining whether relationship paths exist to said target entity; and
(i) identifying said relationship paths.

2. A method according to claim 1 wherein said user augments said central database with proprietary information.

3. A method according to claim 1 further comprising the step of maintaining said central database.

4. A method according to claim 1 wherein the step of integrating further comprises the step of mapping unique identifiers in said client database to said central database.

5. A method according to claim 1 where the client has the option of either confidentially maintaining its proprietary contact information on its internal Client Relation Management system or using the central database system as its Client Relation Management system.

6. A method according to claim 1 wherein at least part of said client database of contact information remains confidential when loaded into said central database.

7. A method of identifying a relationship from a user to a target entity via the global computer communication network having a host computer with a front end interface and at least one remote computer comprising the steps of:
(a) establishing a central database of combined public and private information comprising a plurality of items of contact information;
(b) assigning a unique, relational identifier to each item of contact information in said central database;
(c) obtaining at least one client database of contact information comprising a plurality of items of contact information;
(d) assigning a unique, relational identifier to each item of contact information in said client database;
(e) loading said client database into said central database;
(f) integrating said central database with said client database;
(g) entering a target entity by said user; and
(h) determining whether a relationship path exists from said user to said target entity; and
(i) identifying said relationship paths.

8. A method according to claim 1 where more than one relationship path exists, and the shortest relationship path is determined using a shortest path algorithm.

9. A method according to claim 8 where said shortest relationship path is a first degree of separation, resulting in a direct relationship between a user and said target entity.

10. A method according to claim 8 where said shortest relationship path is a second degree of separation, resulting in a user to a second party, and a second party to a target entity relationship.

11. A method according to claim 8 where said shortest relationship path is a third degree of separation, resulting in a user to a second party, a second party to a third party, and a third party to a target entity relationship.

12. A method of identifying a relationship path from a user to a target entity comprising the steps of:
(a) establishing a central database of combined public and private information comprising a plurality of items of contact information;
(b) assigning a unique, relational identifier to each item of contact information in said central database;
(c) obtaining at least one client database of contact information comprising a plurality of items of contact information;
(d) assigning a unique, relational identifier to each item of contact information in said client database;
(e) loading said client database into said central database;
(f) integrating said central database with said client database;
(g) entering a target entity by said user;
(h) determining whether a plurality of relationship paths exist from said user to said target entity;
(i) identifying said plurality of relationship paths;
(j) assigning a score to each of said relationship paths;
(k) determining the shortest relationship path using said score and a shortest path algorithm; and
(l) displaying said relationship paths to user in ranked order based on assigned score.

13. A method according to claim 12 wherein said score is determined by assigning a value to each relationship path depending upon the type of relationship and its degree of separation, with the lowest score indicating the best path.

14. A method according to claim 13 wherein said the scoring system is alphabetical, the lowest score indicated by an “A.”

15. A method according to claim 14 wherein the step of assigning comprises the steps of:
(a) assigning an “A” when said user has a direct relationship with said target entity;
(b) assigning a “B” when said user covers said target entity in its course of business;
(c) assigning a “C” when a second party has a direct relationship with said target entity; and
(d) assigning a “D” when a second party covers the entire course of business of said target entity.

16. A method of identifying a relationship path from a user to a target entity comprising the steps of:
(a) establishing a central database of combined public and private information comprising a plurality of items of contact information;
(b) assigning a unique, relational identifier to each item of contact information in said central database;
(c) obtaining at least one client database of contact information comprising a plurality of items of contact information;
(d) assigning a unique, relational identifier to each item of contact information in said client database;
(e) loading said client database into said central database;
(f) integrating said central database with said client database;
(g) entering a target entity by said user;
(h) determining whether a plurality of relationship paths exists from said user to said target entity;
(i) identifying no relationship path with a first or second degree of separation from said user to said target entity;
(j) identifying at least one relationship path with a third degree of separation from said user to said target entity;
(k) assigning a score to each said relationship path;
(l) determining the shortest relationship path using said score and a shortest path algorithm; and
(m) displaying said relationship paths to user in ranked order based on assigned score.

17. A method according to claim 16 where said third degree of separation relationship results in a user to a second party, a second party to a third party, and a third party to a target entity relationship.

18. A method according to claim 16 wherein said score is determined by assigning a value to each relationship path depending upon the type of relationship, with the lowest score indicating the best path.

19. A method according to claim 16 wherein determining said score comprises the steps of:
(a) determining a first score for each relationship path from said user to the third party;
(b) determining a second score for each relationship path from said third party to said target entity;
(c) adding said first scores with said second scores; and
(d) determining the lowest combined score, which is the best score, and therefore the shortest path using the shortest path algorithm.

20. A method according to claim 19 wherein said scores are determined by assigning a value to each relationship path depending on the type of relationship, with the lowest score indicating the best path.

21. A method according to claim 20 where the scoring system is alphabetical, the lowest score indicated by an “A.”

22. A method according to claim 21 where determining said first score comprises the steps of:
(a) assigning an “A” when said user has a direct relationship with said third party;
(b) assigning a “B” when the user covers said third party in its course of business;
(c) assigning a “C” when a second party has a direct relationship with said third party; and
(d) assigning a “D” when a second party covers the entire course of business of said third party.

23. A method according to claim 21 where determining said second score comprises the steps of:
(a) assigning an “A” when the third party is a board member with said target entity;
(b) assigning a “B” when the third party works with said target entity;
(c) assigning a “C” when the third party covers said target entity;
(d) assigning a “D” when the third party works at the company where said target entity is a board member; and
(e) assigning an “E” when the third party is a board member at the company where said target entity works.

24. A method of identifying a relationship path from a starting entity to a target entity comprising the steps of:
(a) establishing a central database of combined public and private information comprising a plurality of items of contact information;
(b) assigning a unique, relational identifier to each item of contact information in said central database;
(c) obtaining at least one client database of contact information comprising a plurality of items of contact information;
(d) assigning a unique, relational identifier to each item of contact information in said client database;
(e) loading said client database into said central database;
(f) integrating said central database with said client database;
(g) entering a starting entity by a user;
(h) entering a target entity by said user;
(i) determining whether a plurality of relationship paths exist from said starting entity to said target entity;
(j) identifying said plurality of relationship paths;
(k) assigning a score to each of said relationship paths;
(l) determining the shortest relationship path using said score and a shortest path algorithm; and
(m) displaying said relationship paths to user in ranked order based on assigned score.

25. A method according to claim 24 wherein said score is determined by assigning a value to each relationship path depending upon the type of relationship and its degree of separation, with the lowest score indicating the best path.

26. A method according to claim 25 wherein said scoring system is alphabetical, the lowest score indicated by an “A.”

27. A method according to claim 26 where the step of assigning comprises the steps of:
(a) assigning an “A” when said second party has a direct relationship with said target entity;
(b) assigning a “B” when said second party covers the entire course of business of said target entity;
(c) assigning a “C” when a second party has a direct relationship with said target entity; and
(d) assigning a “D” when a second party covers the entire course of business of said target entity.

28. A method of identifying a relationship path from a starting entity to a target entity comprising the steps of:
(a) establishing a central database of combined public and private information comprising a plurality of items of contact information;
(b) assigning a unique, relational identifier to each item of contact information in said central database;
(c) obtaining at least one client database of contact information comprising a plurality of items of contact information;
(d) assigning a unique, relational identifier to each item of contact information in said client database;
(e) loading said client database into said central database;
(f) integrating said central database with said client database;
(g) entering a starting entity by a user;
(h) entering a target entity by said user;
(i) determining whether a plurality of relationship paths exists from said starting entity to said target entity;
(j) identifying no relationship path with a first or second degree of separation from said starting entity to said target entity;
(k) identifying at least one relationship path with a third degree of separation from said starting entity to said target entity;
(l) assigning a score to each said relationship path;
(m) determining the shortest relationship path using said score and a shortest path algorithm; and
(n) displaying said relationship paths to user in ranked order based on assigned score.

29. A method according to claim 28 wherein said third degree of separation relationship results in a person to a second party, a second party to a third party, and a third party to a target entity relationship.

30. A method according to claim 28 wherein said score is determined by assigning a value to each relationship path depending upon the type of relationship, with the lowest score indicating the best path.

31. A method according to claim 28 wherein determining said score comprises the steps of:
(a) determining a first score for each relationship path from said person to the third party;
(b) determining a second score for each relationship path from said third party to said target entity;
(c) adding said first scores with said second scores; and
(d) determining the lowest combined score, which is the best score, and therefore the shortest path using the shortest path algorithm.

32. A method according to claim 31 wherein said scores are determined by assigning a value to each relationship path depending on the type of relationship, with the lowest score indicating the best path.

33. A method according to claim 32 where said scoring system is alphabetical, the lowest score indicated by an “A.”

34. A method according to claim 33 where determining said first score comprises the steps of
(a) assigning an “A” when said person has a direct relationship with said third party;
(b) assigning a “B” when said person covers the entire course of business of said third party;
(c) assigning a “C” when a second party has a direct relationship with said third party; and
(d) assigning a “D” when a second party covers the entire course of business of said third party.

35. A method according to claim 33 where determining said second score comprises the steps of:
(a) assigning an “A” when the third party is a board member with said target entity;
(b) assigning a “B” when the third party works with said target entity;
(c) assigning a “C” when the third party covers said target entity;
(d) assigning a “D” when the third party works at the company where said target entity is a board member; and
(e) assigning an “E” when the third party is a board member at the company where said target entity works.

36. A method according to claim 12 where identifying said plurality of relationship paths comprises the steps of:
(a) identifying a first degree of separation when there is a direct relationship between said user and said target entity;
(b) identifying a second degree of separation when there is a relationship resulting in a user to a second party, and a second party to a target entity relationship;
(c) identifying a third degree of separation when there is a relationship resulting in a user to a second party, a second party to a third party, and a third party to a target entity relationship;
(d) identifying a fourth degree of separation when there is a relationship resulting in a user to a second party, a second party to a third party, a third party to a fourth party, and a fourth party to a target entity relationship;
(e) identifying a fifth degree of separation when there is a relationship resulting in a user to a second party, a second party to a third party, a third party to a fourth party, a fourth party to a fifth party, and a fifth party to a target entity relationship; and
(f) identifying a sixth degree of separation when there is a relationship resulting in a user to a second party, a second party to a third party, a third party to a fourth party, a fourth party to a fifth party, a fifth party to a sixth party, and a sixth party to a target entity relationship.

37. A method according to claim 36 wherein relationship paths with infinite degrees of separation are identified.

38. A method according to claim 24 where identifying said plurality of relationship paths comprises the steps of:
(a) identifying a first degree of separation when there is a direct relationship between said starting entity and said target entity;
(b) identifying a second degree of separation when there is a relationship resulting in a starting entity to a second party, and a second party to a target entity relationship;
(c) identifying a third degree of separation when there is a relationship resulting in a starting entity to a second party, a second party to a third party, and a third party to a target entity relationship;
(d) identifying a fourth degree of separation when there is a relationship resulting in a starting entity to a second party, a second party to a third party, a third party to a fourth party, and a fourth party to a target entity relationship;
(e) identifying a fifth degree of separation when there is a relationship resulting in a starting entity to a second party, a second party to a third party, a third party to a fourth party, a fourth party to a fifth party, and a fifth party to a target entity relationship; and
(f) identifying a sixth degree of separation when there is a relationship resulting in a starting entity to a second party, a second party to a third party, a third party to a fourth party, a fourth party to a fifth party, a fifth party to a sixth party, and a sixth party to a target entity relationship.

39. A method according to claim 38 wherein relationship paths with infinite degrees of separation are identified.

40. A method of identifying a relationship path from a starting entity to a target entity comprising the steps of:
(a) establishing a central database of combined public and private information comprising a plurality of items of contact information;
(b) assigning a unique, relational identifier to each item of contact information in said central database;
(c) entering a starting entity by a user;
(d) entering a target entity by said user;
(e) determining whether a plurality of relationship paths exist from said starting entity to said target entity;
(f) identifying said plurality of relationship paths;
(g) assigning a score to each of said relationship paths;
(h) determining the shortest relationship path using said score and a shortest path algorithm; and
(i) displaying said relationship paths to user in ranked order based on assigned score.

41. A method of identifying a relationship path from a user or starting entity to a target entity comprising the steps of establishing a computer platform which includes an algorithm for determining the shortest path between a user or starting entity and target entity:
(a) establishing a central database of combined public and private information comprising a plurality of items of contact information;
(b) assigning a unique, relational identifier to each item of contact information in said central database;
(c) obtaining at least one client database of contact information comprising a plurality of items of contact information;
(d) assigning a unique, relational identifier to each item of contact information in said client database;
(e) loading said client database into said central database;
(j) integrating said central database with said client database;
(k) providing a user interface to said platform which allows a user to input the identities of the user or starting entity and the target entity;
(l) determining whether relationship paths exist from said user or starting entity to said target entity; and
(m) identifying said relationship paths.
